(19) United States
(12) Patent Application Publication
(10) Pub. No.: US 2014/0226477 A1
(43) Pub. Date: Aug. 14, 2014

(54) Method, Apparatus, and System for Improving user Experience of Small Flow User

(71) Applicant: Huawei Technologies Co., Ltd., Shenzhen (CN)

(72) Inventors: Bo Xie, Shenzhen (CN); Le Xi, Shenzhen (CN)

(73) Assignee: HUAWEI TECHNOLOGIES CO., LTD., Shenzhen (CN)

(21) Appl. No.: 14/255,449

(22) Filed: Apr. 17, 2014

Related U.S. Application Data
(63) Continuation of application No. PCT/CN2012/077632, filed on Jun. 27, 2012.

(30) Foreign Application Priority Data
Oct. 19, 2011 (CN) 201110320359.3

(51) Int. Cl. H04L 12/851

(52) U.S. Cl. CPC H04L 47/24
USPC 370/234

(57) ABSTRACT

Embodiments of the present invention disclose a method, an apparatus, and a system for improving user experience of a small flow user. A base station controller (BSC) periodically collects statistics on an average data transmission rate of a terminal. The BSC compares the average data transmission rate with a set threshold and determines whether the average data transmission rate is smaller than the set threshold. The BSC sends a first priority adjustment command to a base transceiver station BTS if the average data transmission rate is smaller than the set threshold. The first priority adjustment command carries information of adjusting a scheduling priority of the terminal to a high priority, so that the BTS can adjust the scheduling priority of the terminal to the high priority.

This application is a continuation of International Application No. PCT/CN2012/077632, filed on Jun. 27, 2012, which claims priority to Chinese Patent Application No. 201110320359.3, filed on Oct. 19, 2011, both of which are hereby incorporated by reference in their entireties.

### TECHNICAL FIELD

The present invention relates to the field of communications technologies and, in particular embodiments, to a method, an apparatus, and a system for improving user experience of a small flow user.

### BACKGROUND

On a radio access network, when data of a user is transmitted, to improve bandwidth utilization, a resource such as an air interface is often shared by multiple users. Radio services are classified into multiple types, for example, web browsing, VoIP (voice over Internet protocol) such, online games, and an FTP (file transfer protocol). Some services belong to delay sensitive services, for example, the VoIP and the online games. When a user uses these services, an increase of a delay obviously reduces user experience, and therefore, allocation and scheduling of a resource such as an air interface directly influences the user experience. Different users use different services, and traffic generated by the users is different. When multiple users share a bandwidth resource, because a bandwidth is limited, the users compete with each other, and a user with a large capacity demand will preempt a resource of a small flow user, causing a data transmission delay of the small flow user to increase. A service used by the small flow user is often a delay sensitive service, and therefore, user experience of the small flow user obviously declines.

In the prior art, to solve a problem that user experience of a small flow user is poorer when users compete for a resource than that in normal times, a DPI (deep packet inspection) technology is often used to perform packet analysis; a service type at an application layer is identified in a transmission layer, that is, a specific service type such as web browsing, VoIP, and an FTP is identified, and a different scheduling priority is set according to the specific service type, and therefore, the resource is preferentially allocated to a service with a high priority, ensuring quality of the delay sensitive service.

The inventor finds that the prior art goes against a principle of protocol layer transparency. It's The DPI consumes too much CPU, increasing device costs; and services at the application layer change frequently, requiring the DPI to continuously adapt to changes at the application layer.

### SUMMARY OF THE INVENTION

Embodiments of the present invention provide a method, an apparatus, and a system for improving user experience of a small flow user, which are used to solve a problem that user experience of a small flow user declines when users compete for a resource.

In one aspect, the present invention provides a method for improving user experience of a small flow user. A base station controller (BSC) periodically collects statistics on an average data transmission rate of a terminal. The BSC compares the average data transmission rate with a set threshold and determines whether the average data transmission rate is smaller than the set threshold. The BSC sends a first priority adjustment command to a base transceiver station BTS if the average data transmission rate is smaller than the set threshold. The first priority adjustment command carries information of adjusting a scheduling priority of the terminal to a high priority, so that the BTS adjusts the scheduling priority of the terminal to the high priority.

In another aspect, the present invention provides a base station controller (BSC) for improving user experience of a small flow user. A statistics collecting module is configured to periodically collect statistics on an average data transmission rate of a terminal. A comparing module is configured to compare the average data transmission rate with a set threshold and to determine whether the average data transmission rate is smaller than the set threshold. A sending module is configured to send a priority adjustment command to a base transceiver station BTS if the average data transmission rate is smaller than the set threshold. The command carries information of adjusting a scheduling priority of the terminal to a high priority.

In still another aspect, the present invention provides a system for improving user experience of a small flow user. A base station controller BSC is configured to periodically collect statistics on an average data transmission rate of a terminal, to compare the average data transmission rate with a set threshold, and to send a first priority adjustment command to a base transceiver station BTS if the average data transmission rate is smaller than the set threshold. The first priority adjustment command carries information of adjusting a scheduling priority of the terminal to a high priority. The base transceiver station BTS is configured to receive the first priority adjustment command sent by the BSC and to adjust the scheduling priority of the terminal to the high priority.

Through the method, the BSC, and the system disclosed by the embodiments of the present invention, statistics on an average data transmission rate of a current access terminal is first collected, and then the average data transmission rate is compared with a set threshold, and a scheduling priority of the terminal is accordingly adjusted according to a comparison result, thereby solving a problem that a large flow user preempts a bandwidth resource of a small flow user when users compete for a resource on an access network, ensuring that the small flow user preferentially obtains a frequency band resource, and improving user experience of the small flow user. In the technical solutions provided by the present invention, a service type is not identified, but the scheduling priority of the terminal is adjusted according to the average data transmission rate of the terminal. The technical solutions do not go against a principle of protocol transparency, are easy to be implemented, do not significantly increase device costs, and at the same time, can achieve an objective of ensuring user experience of a small flow user.

### BRIEF DESCRIPTION OF THE DRAWINGS

FIG. 1 is a structural diagram of a CDMA EVDO data communications system in the prior art;

FIG. 2 is a flow chart of a method for improving user experience of a small flow user according to an embodiment of the present invention;

FIG. 3 is a flow chart of a method for improving user experience of a small flow user according to another embodiment of the present invention;

FIG. 4 is a schematic diagram of a base station controller BSC for improving user experience of a small flow user according to an embodiment of the present invention; and

FIG. 5 is a schematic diagram of a system for improving user experience of a small flow user according to an embodiment of the present invention.

### DETAILED DESCRIPTION OF ILLUSTRATIVE EMBODIMENTS

To make the objectives, technical solutions, and advantages of the present invention clearer, the following further describes the technical solutions provided by the present invention in detail with reference to specific embodiments and accompanying drawings.

In a radio communications system, a link with a limited bandwidth generally adopts a strategy of being shared and preempted by multiple users. In this way, bandwidth utilization may be maximized. FIG. 1 shows a structure of a CDMA EVDO (code division multiple access evolution data optimized) data communications system. An Abis interface between a base transceiver station BTS and a base station controller BSC and an air interface between the BTS and a terminal are bottlenecks of the entire system. These two parts of interface resources are both shared by multiple users. When the number of users increases, a bandwidth obtained by each user decreases, and user experience declines. Such decline is particularly obvious for a small flow user.

An embodiment of the present invention discloses a method for improving user experience of a small flow user.

This embodiment takes an EVDO network as an example to describe the method for improving user experience of a small flow user when multiple users compete for a resource.

In this embodiment, a base station controller BSC periodically collects statistics on an average data transmission rate of a user terminal. When the average data transmission rate is smaller than a set threshold, for example, a value of the threshold may be set to 100 kbit/s, it can be determined that a user using the terminal is a small flow user, and a base station scheduling priority of the terminal may be improved. If the multiple users are all small flow users, their scheduling priorities are the same. A scheduling priority of the small flow user is relative to that of a large flow user. Definitions of the small flow user and the large flow user are determined according to their overall average data transmission rates. The value of the threshold may be flexibly set, and change dynamically. To make implementation simple and convenient, a static threshold may also be used.

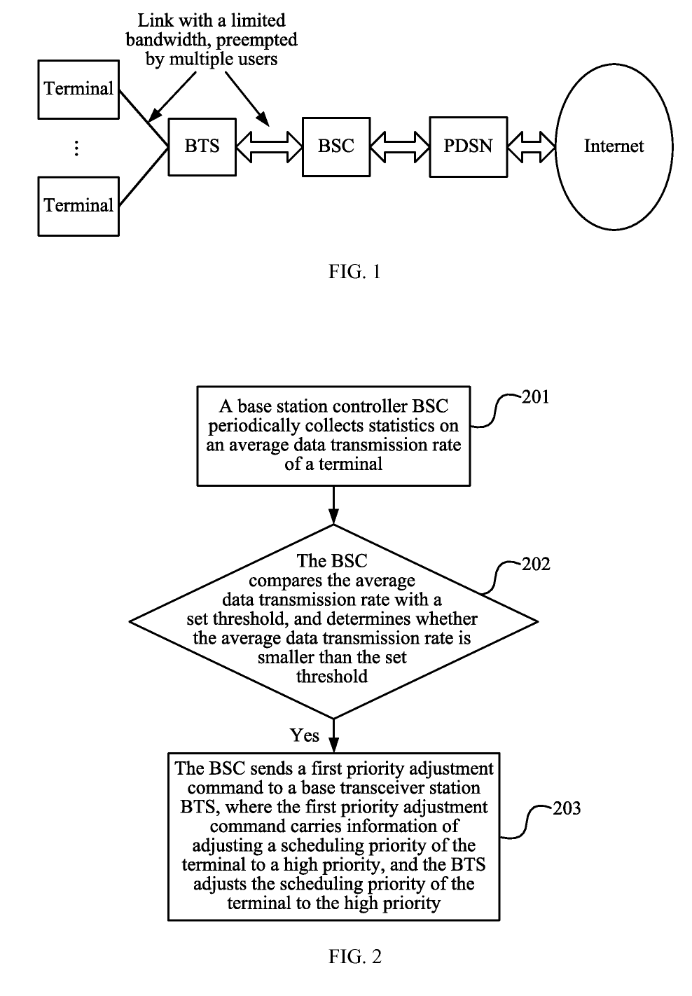

As shown in FIG. 2, an embodiment provides a method for improving user experience of a small flow user. Specific steps are as follows.

Step 201: A base station controller BSC periodically collects statistics on an average data transmission rate of a terminal.

When calculating the average data transmission rate R of the terminal, the BSC may first collect statistics on an amount S Byte of data received or sent by the terminal within each statistical period T. The statistical period may be set according to a factor such as a requirement of an operator, for example, 60 seconds. The BCS may then calculate an average data transmission rate R kbit/s of a current user, where R=S*8/(T*1024). When the statistics on the average data transmission rate of the terminal is collected, statistics on a downlink average data transmission rate may be collected, or statistics on an uplink average data transmission rate may also be collected.

Step 202: The BSC compares the average data transmission rate with a set threshold, and determines whether the average data transmission rate is smaller than the set threshold.

The BSC compares R obtained in step 201 with the set threshold, for example, 100 kbit/s, and may determine, according to a comparison result, whether a corresponding terminal user is a small flow user. If R is smaller than a value of the set threshold, it may be determined that the user is the small flow user; otherwise, the user is a large flow user.

The small flow user is relative to the large flow user. Definitions of the small flow user and the large flow user are determined according to their overall data traffic. The value of the threshold may be flexibly set and change dynamically, for example, may be flexibly set according to the factor such as the requirement of the operator. To make the implementation simple and convenient, a static threshold may also be used.

Step 203: The BSC sends a first priority adjustment command to a base transceiver station BTS if the average data transmission rate is smaller than the set threshold, where the first priority adjustment command carries information of adjusting a scheduling priority of the terminal to a high priority, and the BTS adjusts the scheduling priority of the terminal to the high priority.

A function of adjusting the priority of the terminal may be completed as follows: The BSC sends the first priority adjustment command to the BTS, and the BTS executes the first priority adjustment command. If the average data transmission rate is smaller than the threshold, the BSC sends the priority adjustment command to the BTS, where the command carries the information of adjusting the scheduling priority of the corresponding terminal to the high priority.

The BTS receives the priority adjustment command sent by the BSC, and adjusts the scheduling priority of the corresponding terminal. Because the priority adjustment command received by the BTS carries the information of adjusting the priority of the corresponding terminal to the high priority, the BTS adjusts the scheduling priority of the user to the high priority.

Through the method disclosed by the embodiment of the present invention, a base station controller BSC first collects statistics on an average data transmission rate of a terminal, compares the average data transmission rate with a set threshold, and adjusts a scheduling priority of the corresponding terminal to a high priority if the average data transmission rate is smaller than the threshold, thereby solving a problem that a large flow user preempts a bandwidth resource of a small flow user when users compete for a resource on an access network, ensuring that the small flow user preferentially obtains a frequency band resource, and improving user experience of the small flow user.

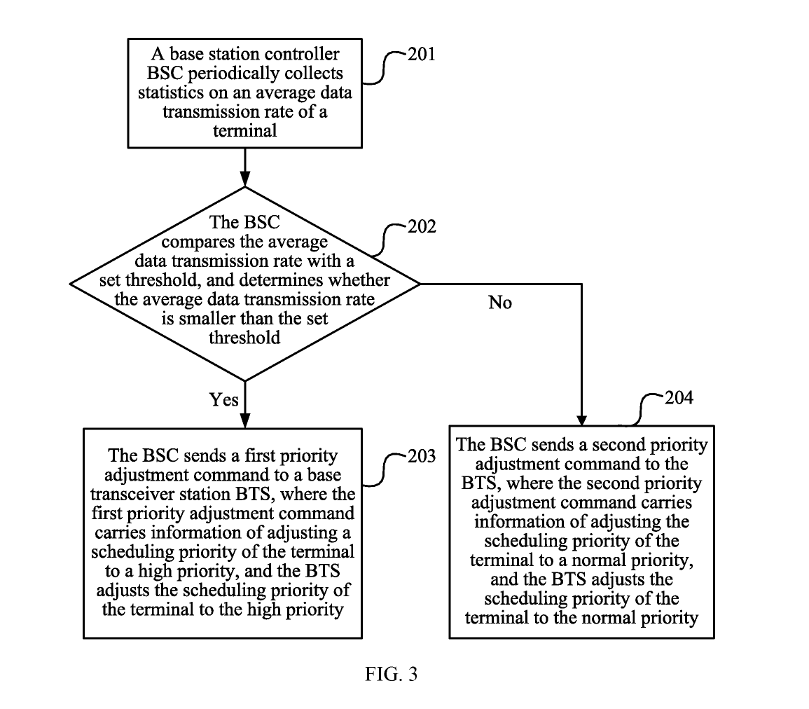

Optionally, based on the foregoing embodiment, as shown in FIG. 3, the method may further include the following step.

Step 204: The BSC sends a second priority adjustment command to the BTS if the average data transmission rate is greater than or equal to the set threshold, where the second priority adjustment command carries information of adjusting the scheduling priority of the terminal to a normal priority, and the BTS adjusts the scheduling priority of the terminal to the normal priority.

A function of adjusting the priority of the terminal may be completed as follows: The BSC sends the second priority adjustment command to the base transceiver station BTS, and the BTS executes the second priority adjustment command. If the average data transmission rate is greater than or equal to the set threshold, the BSC sends the second priority adjustment command to the BTS, where the command carries the information of adjusting the scheduling priority of the corresponding terminal to the normal priority.

The BTS receives the second priority adjustment command sent by the BSC, and adjusts the scheduling priority of the corresponding terminal. Because the priority adjustment command received by the BTS carries the information of adjusting the priority of the corresponding terminal to the normal priority, the BTS adjusts the scheduling priority of the terminal to the normal priority.

In the method embodiment of the present invention, when adjusting the scheduling priority of the terminal, the BTS may implement adjustment by modifying a scheduling priority parameter stored in the BTS. By adjusting the scheduling priority parameter of the terminal to a larger value, a purpose of adjusting the scheduling priority to the high priority is achieved. The greater the scheduling priority parameter is, the greater a scheduling weight of the user is. By default, scheduling priorities of all terminals are the same.

It should be noted that, in the embodiment of the present invention, the scheduling priority of the terminal is divided into two levels, that is, the high priority and the normal priority. By default, all terminals are with the normal priority. The scheduling priority of the terminal may also be divided into multiple levels. A method similar to that in this embodiment may be adopted in a process of improving user experience of a small flow user.

By applying the method disclosed by the embodiment of the present invention, a BSC first collects statistics on an average data transmission rate of a terminal, then compares the average data transmission rate with a set threshold, and accordingly adjusts a scheduling priority of the terminal according to a comparison result, thereby solving a problem that a large flow user preempts a bandwidth resource of a small flow user when users compete for a resource on an access network, ensuring that the small flow user preferentially obtains a frequency band resource, and improving user experience of the small flow user.

It should be noted that, the foregoing method embodiment takes a CDMA EVDO communications system as an example. However, in other communications systems, the method is still applicable, for example, a universal mobile telecommunications system UMTS and long term evolution LTE. In the UMTS system, an access network device includes a base station NodeB and a radio network controller RNC. In an LTE system, an access network device includes a remote radio unit RRU and a baseband unit BBU. Corresponding steps of collecting statistics on an average data transmission rate of a terminal, comparing the average data transmission rate with a set threshold, and sending a priority adjustment command may be implemented by the RNC or the BBU. A step of adjusting a scheduling priority of the terminal may be implemented by the NodeB and the RNC in coordination or the RRU and the BBU in coordination.

An embodiment of the present invention discloses a base station controller BSC for improving user experience of a small flow user.

As shown in FIG. 4, the BSC includes a number of modules. A statistics collecting module 401 is configured to periodically collect statistics on an average data transmission rate of a terminal. A comparing module 402 is configured to compare the average data transmission rate with a set threshold, and to determine whether the average data transmission rate is smaller than the set threshold. A sending module 403 is configured to send a priority adjustment command to a base transceiver station BTS if the average data transmission rate is smaller than the set threshold. The command carries information of adjusting a scheduling priority of the terminal to a high priority, so that the BTS adjusts the scheduling priority of the terminal to the high priority.

In the embodiment, the statistics collecting module 401 may specifically be configured to first collect statistics on an amount of data received or sent by a current access terminal within each statistical period, and then calculate an average data transmission rate of a current user. When the statistics on the average data transmission rate is collected, statistics on a downlink average data transmission rate may be collected, or statistics on an uplink average data transmission rate may also be collected.

In the embodiment, the comparing module 402 is configured to compare the average data transmission rate of the terminal obtained by the module 401 with the set threshold. If the average data transmission rate is smaller than a value of the threshold, it may be determined that the user of the terminal is a small flow user; otherwise, the user is a large flow user.

Optionally, the sending module 403 is further configured to send a priority adjustment command to the BTS when the average data transmission rate is greater than or equal to the set threshold, where the command carries information of adjusting the scheduling priority of the corresponding terminal to a normal priority.

By applying the BSC disclosed by the embodiment of the present invention, statistics on an average data transmission rate of a terminal may be collected, and a priority adjustment command is sent to a BTS according to a result of comparison with a set threshold, so that the BTS adjusts a scheduling priority of the corresponding terminal, thereby ensuring that a small flow user preferentially obtains a frequency band resource, and improving user experience of the small flow user.

An embodiment of the present invention discloses a system for improving user experience of a small flow user.

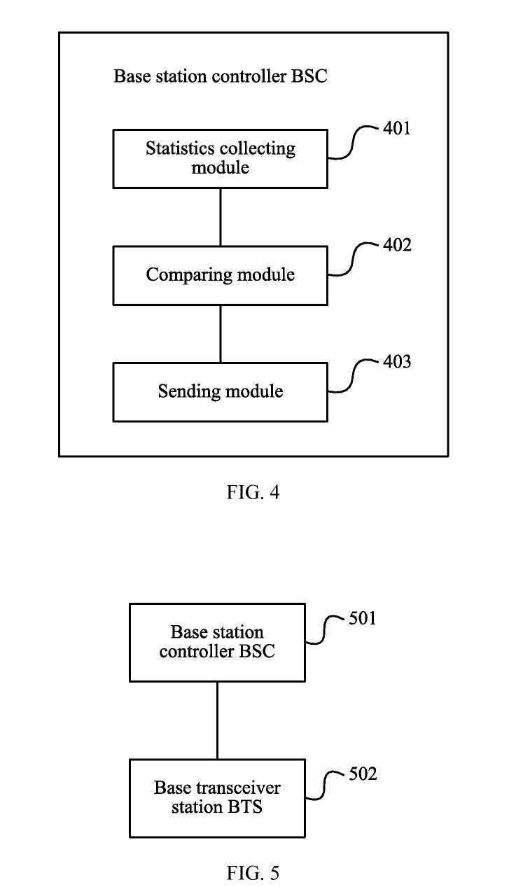

As shown in FIG. 5, the system includes a base station controller BSC 501, which is configured to periodically collect statistics on an average data transmission rate of a terminal, to compare the average data transmission rate with a set threshold, and to send a first priority adjustment command to a base transceiver station BTS if the average data transmission rate is smaller than the set threshold. The first priority adjustment command carries information of adjusting a scheduling priority of the terminal to a high priority. When the statistics on the average data transmission rate of the terminal is collected, statistics on a downlink average data transmission rate may be collected, or statistics on an uplink average data transmission rate may also be collected. The base transceiver station BTS 502 is configured to receive the first priority adjustment command sent by the BSC and to adjust the scheduling priority of the terminal to the high priority.

Based on the foregoing embodiment, optionally, the BSC is further configured to send a second priority adjustment command to the BTS when the average data transmission rate is greater than or equal to the set threshold. The second priority adjustment command carries information of adjusting the scheduling priority of the corresponding terminal to a normal priority. The BTS is configured to receive the second priority adjustment command sent by the BSC and to adjust the scheduling priority of the corresponding terminal to the normal priority.

It should be noted that, in the foregoing system embodiment, the scheduling priority of the terminal is divided into two levels, that is, the normal priority and the high priority. By default, all terminals are with the normal priority. The scheduling priority of the terminal may also be divided into multiple levels. A structure similar to that in this embodiment may be adopted in the system for improving user experience of a small flow user.

By applying the system disclosed by the embodiment of the present invention, a BSC first collects statistics on an average data transmission rate of a terminal, then compares the average data transmission rate with a set threshold, and sends a priority adjustment command to a BTS according to a comparison result. The BTS accordingly adjusts a scheduling priority of the terminal, thereby solving a problem that a large flow user preempts a bandwidth resource of a small flow user when users compete for a resource on an access network, ensuring that the small flow user preferentially obtains a frequency band resource, and improving user experience of the small flow user.

It should be noted that, the foregoing system embodiment takes a CDMA EVDO communications system as an example. However, in other communications systems, the system is still applicable, for example, a universal mobile telecommunications system UMTS and long term evolution LTE. In the UMTS system, an access network device includes a base station NodeB and a radio network controller RNC; in an LTE system, an access network device includes a remote radio unit RRU and a baseband unit BBU. Corresponding functions of collecting statistics on a data transmission rate of a terminal, comparing the average data transmission rate with a set threshold, and sending a priority adjustment command may be implemented by the RNC or the BBU. A function of adjusting a scheduling priority of the terminal may be implemented by the NodeB or the RRU.

Through the method, the apparatus, and the system disclosed by the embodiments of the present invention, statistics on an average data transmission rate of a current access terminal is first collected, and then the average data transmission rate is compared with a set threshold, and a scheduling priority of the terminal is accordingly adjusted according to a comparison result, thereby solving a problem that a large flow user preempts a bandwidth resource of a small flow user when users compete for a resource on an access network, ensuring that the small flow user preferentially obtains a frequency band resource, and improving user experience of the small flow user. In the technical solutions provided by the present invention, a service type is not identified, but the scheduling priority of the terminal is adjusted according to the average data transmission rate of the terminal. The technical solutions do not go against a principle of protocol transparency, are easy to be implemented, do not significantly increase device costs, and at the same time, can achieve an objective of ensuring user experience of a small flow user.

Through the description of the foregoing implementation manners, persons skilled in the art may clearly understand that the present invention may be implemented by software plus a necessary hardware platform, and certainly, may also be implemented by hardware, but in most cases, the former is a preferred implementation manner. Based on such understanding, all or a part of the technical solutions of the present invention contributing to the prior art may be implemented in a form of a software product. The computer software product may be stored in a storage medium, such as a ROM/RAM, a magnetic disk, and an optical disk, and includes several instructions for instructing a computer device (which may be a personal computer, a server, or a network device, or the like) to perform the method described in each embodiment or certain parts of the embodiments of the present invention.

The foregoing embodiments are merely intended for describing the technical solutions of the present invention other than limiting the present invention. Although the present invention is described in detail with reference to the foregoing embodiments, persons of ordinary skill in the art should understand that they may still make modifications to the technical solutions described in the foregoing embodiments, or make equivalent replacements to some technical features of the technical solutions described in the foregoing embodiments; however, these modifications or replacements do not make the essence of the corresponding technical solutions depart from the spirit and scope of the technical solutions of the embodiments of the present invention.

What is claimed is:

1. A method for improving user experience of a small flow user, the method comprising:
periodically collecting, by a base station controller (BSC), statistics on an average data transmission rate of a terminal;
comparing, by the BSC, the average data transmission rate with a set threshold;
determining whether the average data transmission rate is smaller than the set threshold; and
sending, by the BSC, a first priority adjustment command to a base transceiver station (BTS) if the average data transmission rate is smaller than the set threshold, wherein the first priority adjustment command carries information of adjusting a scheduling priority of the terminal to a high priority, so that the BTS can adjust the scheduling priority of the terminal to the high priority.

2. The method according to claim 1, wherein the average data transmission rate is a downlink average data transmission rate or an uplink average data transmission rate.

3. The method according to claim 1, wherein the set threshold changes dynamically.

4. The method according to claim 1 wherein the set threshold is static.

5. The method according to claim 1, wherein after the comparing the average data transmission rate with the set threshold and determining whether the average data transmission rate is smaller than the set threshold, the method further comprises:
sending, by the BSC, a second priority adjustment command to the BTS if the average data transmission rate is greater than or equal to the set threshold, wherein the second priority adjustment command carries information of adjusting the scheduling priority of the terminal to a normal priority, so that the BTS adjusts the scheduling priority of the terminal to the normal priority.

6. The method according to claim 5, wherein the scheduling priority of the terminal is divided into two levels, the two levels being the high priority and the normal priority.

7. A base station controller (BSC) for improving user experience of a small flow user, the BCS comprising:
a statistics collecting module, configured to periodically collect statistics on an average data transmission rate of a terminal;
a comparing module, configured to compare the average data transmission rate with a set threshold and to determine whether the average data transmission rate is smaller than the set threshold; and
a sending module, configured to send a priority adjustment command to a base transceiver station (BTS) when the average data transmission rate is smaller than the set threshold, wherein the command carries information related to adjusting a scheduling priority of the terminal to a high priority.

8. The BSC according to claim 7, wherein the average data transmission rate is a downlink average data transmission rate.

9. The BSC according to claim 7, wherein the average data transmission rate is an uplink average data transmission rate.

10. The BSC according to claim 7, wherein the sending module is further configured to send the priority adjustment command to the BTS when the average data transmission rate is greater than or equal to the set threshold, wherein the command carries information of adjusting the scheduling priority of the terminal to a normal priority.

11. A system for improving user experience of a small flow user, the system comprising:
a base station controller (BSC); and
a base transceiver station (BTS);
wherein the BCS is configured to periodically collect statistics on an average data transmission rate of a terminal, to compare the average data transmission rate with a set threshold, and to send a first priority adjustment command to a base transceiver station BTS when the average data transmission rate is smaller than the set threshold, wherein the first priority adjustment command carries information related to adjusting a scheduling priority of the terminal to a high priority; and
wherein the BTS is configured to receive the first priority adjustment command sent by the BSC and to adjust the scheduling priority of the terminal to the high priority.

12. The system according to claim 11, wherein the average data transmission rate is a downlink average data transmission rate.

13. The system according to claim 11, wherein the average data transmission rate is an uplink average data transmission rate.

14. The system according to claim 11, wherein the BSC is further configured to send a second priority adjustment command to the BTS when the average data transmission rate is greater than or equal to the set threshold, wherein the second priority adjustment command carries information of adjusting the scheduling priority of a corresponding terminal to a normal priority, and wherein the BTS is configured to receive the second priority adjustment command sent by the BSC and to adjust the scheduling priority of the terminal to the normal priority.

15. The system according to claim 14, wherein the scheduling priority of the terminal is divided into two levels, the two levels being the high priority and the normal priority.
